(19) United States
(12) Patent Application Publication
(10) Pub. No.: US 2015/0178768 A1
(43) Pub. Date: Jun. 25, 2015

(54) SYSTEM AND METHOD FOR INTERMEDIATING ELECTRONIC COMMERCE USING OFFLINE TRANSACTION INFORMATION

(71) Applicant: SK PLANET CO., LTD., Seongnam-si, Gyeonggi-do (KR)

(72) Inventors: Yoon Bong Yoo, Seoul (KR); Byeoong Soon Hwang, Seoul (KR); Jae Ho Koh, Seoul (KR); Mi Young Park, Seoul (KR)

(21) Appl. No.: 14/406,594

(22) PCT Filed: Jul. 9, 2013
(86) PCT No.: PCT/KR2013/006094

§ 371 Date: Dec. 9, 2014

(30) Foreign Application Priority Data
Jul. 11, 2012 (KR) 10-2012-0075694

(51) Int. Cl. G06Q 30/02

(52) U.S. Cl. CPC G06Q 30/0241; G06Q 30/0267; G06Q 30/0277

(57) ABSTRACT

Disclosed are a system and a method for intermediating an electronic commerce using offline transaction information, the system comprising a product information registration device for receiving and transmitting product and seller information; a transaction information collecting device for collecting and transmitting the information on the transaction performed based on the product information; a transaction information management device for receiving the product, the seller and the transaction information, calculating the degree of exposure of a product based on the exposure degree calculation standard set for each transaction information, calculating the weighted degree of exposure for each distribution channel of the product, selecting a preset number of distribution channels in the order of the weighted degree of exposure and displaying the product information on the relevant distribution channel; and an electronic commerce device for intermediating an electronic commerce based on the product information received from the transaction information management device.

### TECHNICAL FIELD

The present invention relates to an electronic commerce intermediating system using offline transaction information and a method thereof, and more specifically, to an electronic commerce intermediating system using offline transaction information and a method thereof, which can expand sales encounters of offline products, revitalize electronic commerce and improve advertisement effects by collecting product information and transaction information through an offline payment terminal and providing information on a corresponding product to an electronic commerce site or an advertisement platform optimized to trading of the corresponding product.

### BACKGROUND ART

In an online market in which electronic commerce is established, there are seller groups selling products, buyer groups buying the products, and online shopping mall companies and advertisement companies providing trading environments.

Generally, a seller may sell his or her products by connecting to a shopping mall operated by an online shopping mall company using a seller terminal (an information communication device such as a personal computer or the like), manually registering information on his or her products one by one in an electronic commerce management page provided by a shopping mall server, and inputting various kinds of information. In addition, the seller requests a desired site such as an online shopping mall, a portal site, a mobile site or the like to post an advertisement to promote sales of the products.

However, the seller himself or herself should upload the products onto each shopping mall server and manage stocks thereof through a manual work, and, in addition, the seller should search for a site which can post the advertisement and request posting of the advertisement on a desired site.

Like this, since this is an environment based on a manual work in which a seller himself or herself should select and request a work of registering products or posting advertisements in order to sell the products through an online market, the seller should invest more time and manpower and search for relevant sites, and it is difficult to select a site which can maximize a product sales effect and an advertisement effect since the site is selected based on a subjective judgment.

### DISCLOSURE OF INVENTION

### Technical Problem

Therefore, the present invention has been made in view of the above problems, and it is an object of the present invention to provide an electronic commerce intermediating system using offline transaction information and a method thereof, which can expand sales encounters of offline products, revitalize electronic commerce and improve advertisement effects by collecting product transaction information using an offline payment terminal used in an offline market, analyzing the collected transaction information and providing information on a corresponding product to an electronic commerce site or an advertisement platform optimized to trading of the corresponding product.

### Technical Solution

To accomplish the above object, according to one aspect of the present invention, there is provided an electronic commerce intermediating system using offline transaction information, the system including: a product information registration device for receiving and transmitting product information and seller information; a transaction information collecting device for collecting and transmitting information on a transaction concluded according to the product information; a transaction information management device for receiving the product information, the seller information and the transaction information, calculating a degree of exposure of a product based on an exposure degree calculation standard set for each transaction information, calculating a weighted degree of exposure for each distribution channel of the product by assigning a weighted value set for each distribution channel to the calculated degree of exposure, selecting a predetermined number of distribution channels in descending order of the weighted degree of exposure, and posting the product information on a corresponding distribution channel; and an electronic commerce device for intermediating electronic commerce based on the product information received from the transaction information management device.

Here, the electronic commerce intermediating system may further include an advertisement device for posting an advertisement corresponding to the product information according to the product information received from the transaction information management device.

According to another aspect of the present invention, there is provided a product transaction information management device including: a product information registration unit for receiving and registering product information and seller information; a transaction information collecting unit for collecting and storing information on a transaction concluded according to the product information; a product exposure degree calculation unit for receiving the product information, the seller information and the transaction information and calculating a degree of exposure of a product based on an exposure degree calculation standard set for each transaction information; a weighted exposure degree calculation unit for calculating a weighted degree of exposure for each distribution channel of the product by assigning a weighted value set for each distribution channel to the calculated degree of exposure; and a sales information intermediating unit for selecting a predetermined number of distribution channels in descending order of the weighted degree of exposure and posting the product information on a corresponding distribution channel.

Here, the product information may include at least any one or more of a product name, a product category, a product keyword, a product description, a price and a selling period of the product.

In addition, the transaction information may include at least any one or more of a transaction date, a transaction time, a dealing price, a seller location, a payment frequency and a payment location.

In addition, the sales information intermediating unit may select a predetermined number of distribution channels in descending order of the weighted degree of exposure and transmit the product information to at least any one of an electronic commerce device and an advertisement device on a corresponding distribution channel to post the product information.

According to still another aspect of the present invention, there is provided a control method of a product transaction information management device, the method including the steps of: (a) receiving product information and seller information through a network and registering the information; (b) collecting and storing information on a transaction concluded according to the product information; (c) receiving the product information, the seller information and the transaction information and calculating a degree of exposure of a product based on an exposure degree calculation standard set for each transaction information; (d) calculating a weighted degree of exposure for each distribution channel of the product by assigning a weighted value set for each distribution channel to the calculated degree of exposure; and (e) selecting a predetermined number of distribution channels in descending order of the weighted degree of exposure and transmitting the product information on a corresponding distribution channel.

Here, the product information may include at least any one or more of a product name, a product category, a product keyword, a product description, a price and a selling period of the product.

In addition, the transaction information may include at least any one or more of a transaction date, a transaction time, a dealing price, a seller location, a payment frequency and a payment location.

In addition, step (e) may include the step of selecting a predetermined number of distribution channels in descending order of the weighted degree of exposure and transmitting the product information to at least any one of an online electronic commerce site, an online advertisement site and a mobile advertisement site.

### Advantageous Effects

As described above, the electronic commerce intermediating system using offline transaction information and a method thereof may expand sales encounters of offline products by collecting product transaction information using an offline payment terminal used in an offline market, analyzing the collected transaction information and providing information on a corresponding product to an electronic commerce site or an advertisement platform optimized to trading of the corresponding product.

In addition, the electronic commerce intermediating system using offline transaction information and a method thereof may solve a sales management problem of duplicating information on a product and its price, which are registered by a seller for payment, in online and offline spaces by automatically registering the information in an electronic commerce market and an advertisement platform.

In addition, the electronic commerce intermediating system using offline transaction information and a method thereof may improve a trading success rate by posting a product on an optimum electronic commerce company and an advertisement platform by utilizing product information registered by a seller and transaction information collected in the process of making a payment.

### BRIEF DESCRIPTION OF THE DRAWINGS

FIG. 1 is a view showing the configuration of an electronic commerce intermediating system using offline transaction information according to an embodiment of the present invention.

FIG. 2 shows a control block diagram of a transaction information management device according to an embodiment of the present invention.

FIG. 3 shows a data flow diagram of an electronic commerce intermediating system according to an embodiment of the present invention.

FIG. 4 is a view showing an exposure degree calculation state of a transaction information management device according to an embodiment of the present invention.

FIG. 5 is a flowchart illustrating an electronic commerce intermediating method using offline transaction information according to an embodiment of the present invention.

### DESCRIPTION OF SYMBOLS

100: Product information registration device 150: Transaction information collecting device

200: Transaction information management device 210: Product information registration unit

212: Transaction information collecting unit 214: Product exposure degree calculation unit

216: Weighted exposure degree calculation unit 218: Sales information intermediating unit

220: Product information DB 222: Seller information DB

224: Transaction information DB 300: Electronic commerce device

350: Advertisement device

### MODE FOR INVENTION

The preferred embodiments of the present invention will be hereafter described in detail, with reference to the accompanying drawings. Furthermore, in the drawings illustrating the embodiments of the present invention, elements having like functions will be denoted by like reference numerals and details thereon will not be repeated.

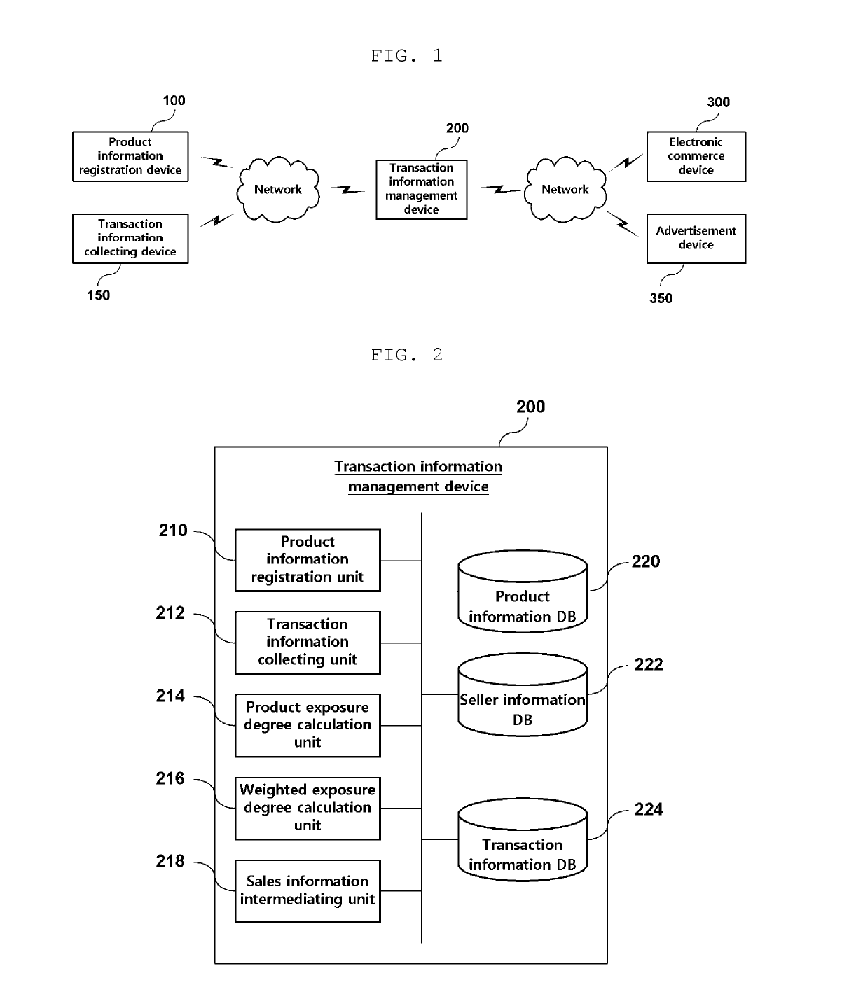

FIG. 1 is a view showing the configuration of an electronic commerce intermediating system using offline transaction information according to an embodiment of the present invention.

As shown in FIG. 1, an electronic commerce intermediating system according to an embodiment of the present invention includes a transaction information management device 200 for managing transaction information of an offline market, a product information registration device 100 for transmitting and receiving data to and from the transaction information management device 200 through a network, a transaction information collecting device 150, an electronic commerce device 300 for intermediating online sales of a product according to the data received from the transaction information management device 200 through a network, and an advertisement device 350 for posting advertisements.

The product information registration device 100 receives product information and product seller information from a seller and transmits the information to the transaction information management device 200. The product information may include a product name, a product category, a product keyword, a product description, a price, a selling period and the like of a product that is desired to be paid using an offline payment terminal. The seller information may include a seller location, a phone number, a seller account, contact information, a business number and the like. The product information registration device 100 may include the offline payment terminal, and, accordingly, the seller may directly register the product information and the seller information through the offline payment terminal, register the product information and the seller information into an integrated product management web site synchronized with the offline payment terminal, or register the product information and the seller information into a sale management system (POS) synchronized with the offline payment terminal. Here, the offline payment terminal is a credit card payment terminal containing a communication module and may include a credit card payment terminal utilizing an NFC mobile phone terminal.

The transaction information collecting device 150 collects information related to a product payment in an offline market and transmits the information to the transaction information management device 200. The transaction information may include a transaction date, a transaction time, a dealing price, a seller location, a payment frequency, a payment location and the like. The transaction information collecting device 150 may include the offline payment terminal.

The transaction information management device 200 receives seller information and product information registered by a seller and transaction information collected in the process of making a payment and selects an electronic commerce device 300 and an advertisement device 350 appropriate to selling and advertising a corresponding product. The transaction information management device 200 may process a degree of exposure of each product for selecting the electronic commerce device 300 and the advertisement device 350 and a weighted degree of exposure for a distribution channel.

The electronic commerce device 300 may include an electronic commerce server of an open marketplace type, an electronic commerce server directly operated by the transaction information management device 200 and the like.

The advertisement device 350 may provide a banner, a keyword search advertisement, a mobile advertisement and the like.

As described above, the present invention may intermediate product sales information through the electronic commerce device 300 and the advertisement device 350 which can make a maximum effect by utilizing the product information and the transaction information registered in an offline payment terminal used by an offline business operator.

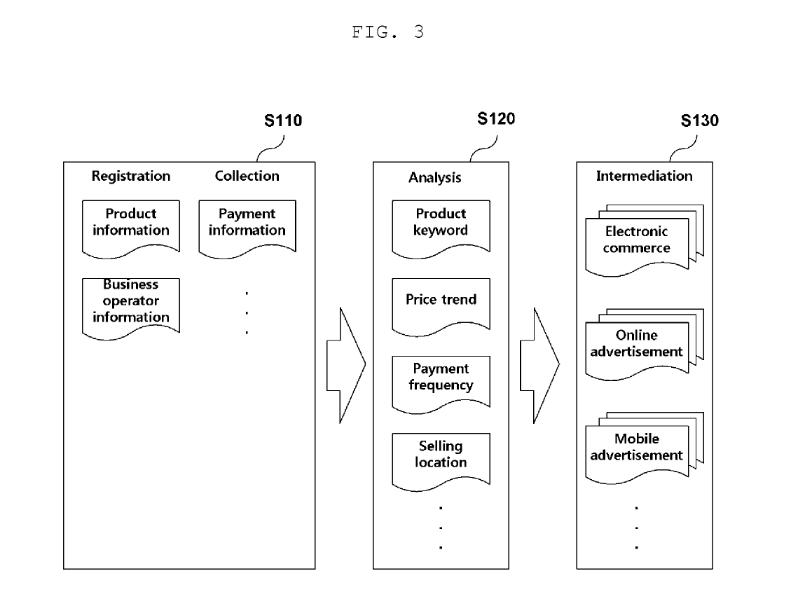

FIG. 2 shows a control block diagram of a transaction information management device 200 according to an embodiment of the present invention.

As shown in FIG. 2, the transaction information management device 200 includes a product information registration unit 210, a transaction information collecting unit 212, a product exposure degree calculation unit 214, a weighted exposure degree calculation unit 216, a sales information intermediating unit 218, a product information DB 220, a seller information DB 222, and a transaction information DB 224.

The product information registration unit 210 receives product information and seller information from the product information registration device 100 and stores the information in the product information DB 220 and the seller information DB 222. The product information stored in the product information DB 220 may include a product name, a product category, a product keyword, a product description, a price, a selling period and the like of a product that is desired to be paid using an offline payment terminal. The seller information stored in the seller information DB 222 may include a seller location, a phone number, a seller account, contact information, a business number and the like.

The transaction information collecting unit 212 receives transaction information of an offline market from the transaction information collecting device 150 and stores the transaction information in the transaction information DB 224. The transaction information stored in the transaction information DB 224 may include a transaction date, a transaction time, a dealing price, a seller location, a payment frequency, a payment location and the like.

The product exposure degree calculation unit 214 calculates a degree of exposure of a product by analyzing the product information and the transaction information based on a predetermined exposure degree calculation standard. The degree of exposure of a product can be calculated as a score between 0 and 100 points. The degree of exposure may be calculated based on keyword information, price information, location information, a payment frequency and the like. For example, a degree of exposure may be calculated for a popular keyword after classifying keywords, and a degree of exposure may be calculated for a product renewing a minimum price through a product price transition analysis. In addition, a degree of exposure may be calculated for a close region through an analysis of geographical distance between a seller, an advertisement exposure region and a popular exposure region, and a degree of exposure may be calculated according to reliability and popularity of a business operator reflecting a payment frequency of the seller.

The weighted exposure degree calculation unit 216 calculates a weighted degree of exposure for a product by assigning a weighted value corresponding to a distribution channel of the electronic commerce device 300 and the advertisement device 350 to the degree of exposure calculated by the product exposure degree calculation unit 214. The distribution channel may be classified into an electronic commerce site, an online advertisement, a mobile advertisement and the like, and items to which a weighted value is assigned can be determined according to the characteristics of each distribution channel. For example, a weighted value can be assigned to a price, a payment frequency and a product keyword in the case of an electronic commerce site, a weighted value can be assigned to a product keyword and a price in the case of an online advertisement, and a weighted value can be assigned to a selling location and a payment frequency in the case of a mobile advertisement. As described above, the weighted degree of exposure can be calculated by assigning a weighted value previously set for each distribution channel to a degree of exposure of a base information item of each product.

The sales information intermediating unit 218 may classify electronic commerce sites and advertisement platforms according to a result of the weighted degree of exposure calculated by the weighted exposure degree calculation unit 216 and intermediate product sale information to a corresponding distribution channel by matching a sales product group having a highest weighted degree of exposure to a distribution channel. In addition, the sales information intermediating unit 218 may select a predetermined number of distribution channels in descending order of the weighted degree of exposure and transmit the product information on a corresponding distribution channel. The sales information intermediating unit 218 may register a sales product in a site of the electronic commerce device 300 or in an online and mobile advertisement platform.

When the sales information intermediating unit 218 registers a sales product in the electronic commerce device 300, it may provide a purchase encounter of a customer by registering the sales product in an electronic commerce site of an open marketplace type, or it may post products of a business operator on behalf of the business operator by registering the business operator as a representative member store of the transaction information management device 200 and intermediate a consumer in an online space to the business operator. In addition, burdens of the business operator for registering and managing products can be minimized by directly entering the electronic commerce site and registering the products by the transaction information management device 200. In addition, even when a transaction is generated through an electronic commerce site, a same settlement process may be shared with a conventional payment terminal by utilizing payment information of a seller registered in the offline payment terminal.

When the sales information intermediating unit 218 registers a sales product in the online advertisement device 350, product sales information may be inserted in a banner or a keyword search advertisement and linked to an electronic commerce site or a sales and advertisement site registered by a seller.

When the sales information intermediating unit 218 registers a sales product in the online advertisement device 350, it may insert product sale information in a mobile advertisement by utilizing seller information registered by a seller and intermediate connection between a buyer and a seller in the form of a phone call connection or a character message connection to the seller or in the form of connecting to an electronic commerce site. In addition, the sales information intermediating unit 218 may connect a seller to a consumer within a close distance by utilizing location information of the seller possessing an offline payment terminal, and it may secure an online and mobile advertisement account of an advertisement company and post an advertisement of a product of a business operator who is in a higher degree of exposure ranking.

According to such a configuration, although a seller does not select an electronic commerce device 300 or an online advertisement device 350 and request or manage registration of the sales product by himself or herself, the product transaction information management device 200 may expand sales encounters by automatically posting a product on an electronic commerce site or an advertisement platform most appropriate to each product.

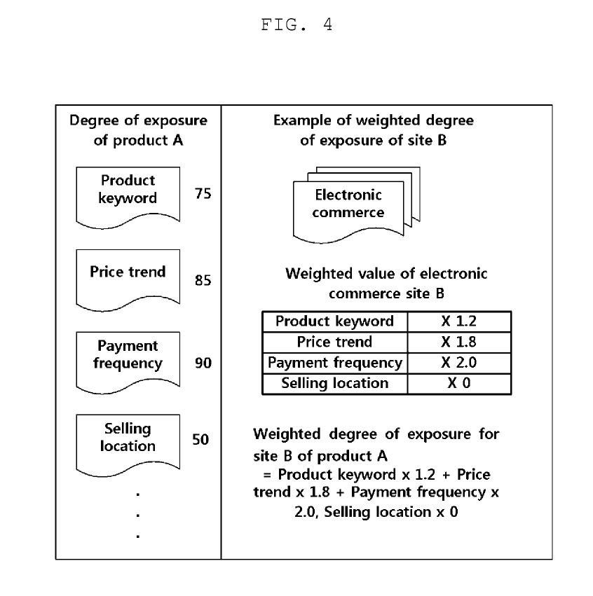

FIG. 3 shows a data flow diagram of an electronic commerce intermediating system according to an embodiment of the present invention.

As shown in FIG. 3, product information, business operator information and payment information are collected at the registration and collection step (S110). The registration and collection step (S110) may be progressed through the product information registration device 100 and the transaction information collecting device 150, and the functions of the product information registration device 100 and the transaction information collecting device 150 can be performed by an offline payment terminal.

In the analysis step (S120) performed by the product transaction information management device 200, data such as a product keyword, a price trend, a payment frequency, a selling location and the like can be an analysis target. In the analysis step (S120), a degree of exposure of a product is calculated for the analysis target data based on a predetermined exposure degree calculation standard, and a weighted degree of exposure is calculated for the product by assigning a weighted value corresponding to a distribution channel of the electronic commerce device 300 and the advertisement device 350 to the calculated degree of exposure.

Then, in the intermediating step (S130), information needed for product sales is registered in the electronic commerce device 300 and the online and mobile advertisement device 350.

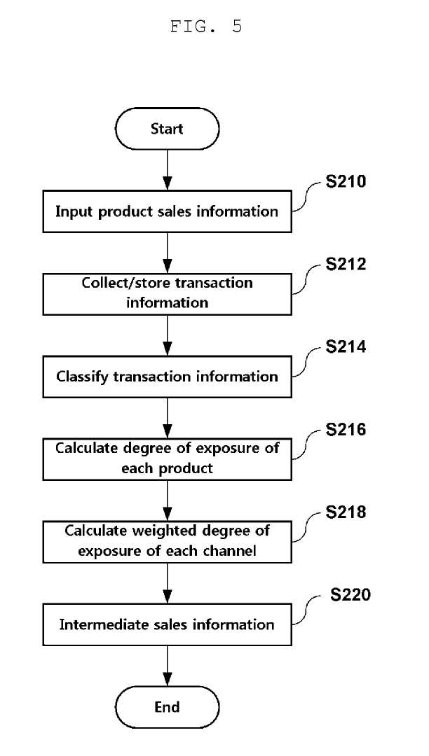

FIG. 4 is a view showing an exposure degree calculation state of a transaction information management device 200 according to an embodiment of the present invention.

As shown in FIG. 4, a degree of exposure of product A is calculated in a predetermined calculation method according to items such as a product keyword, a price trend, a payment frequency, a selling location and the like. Such a degree of exposure can be calculated by the product exposure degree calculation unit 214, and the degree of exposure may be calculated according to a standard set in the system on the basis of 0 to 100 points.

Then, a weighted degree of exposure is calculated for the product by assigning a weighted value corresponding to a distribution channel of the electronic commerce device 300 and the advertisement device 350 to the calculated degree of exposure. The distribution channel may be classified into an electronic commerce site, an online advertisement, a mobile advertisement and the like, and items to which a weighted value is assigned can be determined according to the characteristics of each distribution channel. The embodiment of FIG. 4 shows an example of calculating a weighted degree of exposure of product A for electronic commerce site B. The weighted degree of exposure at electronic commerce site B may be calculated by assigning a weighted value according to a product keyword, a price trend and a payment frequency. Like this, a total of degrees of exposure of product A reflecting the weighted values may be calculated as a weighted degree of exposure of product A for site B.

The product transaction information management device 200 calculates a weighted degree of exposure for each distribution channel through the process described above, selects a predetermined number of distribution channels in descending order of the weighted degree of exposure, and provides product information on a corresponding distribution channel to post sales information or an advertisement.

FIG. 5 is a flowchart illustrating an electronic commerce intermediating method using offline transaction information according to an embodiment of the present invention.

The product information registration unit 210 of the transaction information management device 200 registers product information and seller information received from the product information registration device 100 (S210). The product information and the seller information may be received from an offline payment terminal, and the product information may include a product name, a product category, a product keyword, a product description, a price, a selling period and the like, and the seller information may include a seller location, a phone number, a seller account, contact information, a business number and the like.

The transaction information collecting unit 212 collects transaction information of an offline market from the transaction information collecting device 150 and stores the transaction information (S212). The transaction information collecting unit 212 may receive transaction information such as a transaction date, a transaction time, a dealing price, a seller location, a payment frequency, a payment location and the like from an offline payment terminal and store the transaction information.

The product exposure degree calculation unit 214 of the transaction information management device 200 classifies the transaction information by the category (S214) and calculates a degree of exposure for each product that has been transacted (S216). The product exposure degree calculation unit 214 may calculate a degree of exposure of a product by analyzing the product information and the transaction information based on a predetermined exposure degree calculation standard.

Then, the weighted exposure degree calculation unit 216 calculates a weighted degree of exposure for a product by assigning a weighted value corresponding to a distribution channel of the electronic commerce device 300 and the advertisement device 350 to the degree of exposure calculated by the product exposure degree calculation unit 214. The distribution channel may be classified into an electronic commerce site, an online advertisement, a mobile advertisement or the like, and items to which a weighted value is assigned can be determined according to characteristics of each distribution channel.

The product transaction information management device 200 calculates a weighted degree of exposure for each distribution channel through the process described above, selects a predetermined number of distribution channels in descending order of the weighted degree of exposure, and provides product information on a corresponding distribution channel to post sales information or an advertisement (S220).

Such a control method of a product transaction information management device can be created as a program, and the codes and code segments configuring the program may be easily inferred by the programmers in the art. In addition, the program related to the control method of the product transaction information management device may be stored in an information storage medium that can be read by an electronic device and read and executed by the electronic device.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1-10. (canceled)

11. A product transaction information management device comprising:
a product information registration unit for receiving and registering product information and seller information;
a transaction information collecting unit for collecting and storing information on a transaction concluded according to the product information;
a product exposure degree calculation unit for receiving the product information, the seller information and the transaction information and calculating a degree of exposure of a product based on an exposure degree calculation standard set for each transaction information;
a weighted exposure degree calculation unit for calculating a weighted degree of exposure for each distribution channel of the product by assigning a weighted value set for each distribution channel to the calculated degree of exposure; and
a sales information intermediating unit for selecting a predetermined number of distribution channels in descending order of the weighted degree of exposure and posting the product information on a corresponding distribution channel.

12. The device according to claim 11, wherein the product information includes at least any one or more of a product name, a product category, a product keyword, a product description, a price and a selling period of the product, and the transaction information includes at least any one or more of a transaction date, a transaction time, a dealing price, a seller location, a payment frequency and a payment location.

13. The device according to claim 11, wherein the sales information intermediating unit selects a predetermined number of distribution channels in descending order of the weighted degree of exposure and transmits the product information to at least any one of an electronic commerce device and an advertisement device on a corresponding distribution channel to post the product information.

14. An electronic commerce intermediating system using offline transaction information, the system comprising:
a product information registration device for receiving and transmitting product information and seller information;
a transaction information collecting device for collecting and transmitting information on a transaction concluded according to the product information;
a transaction information management device for receiving the product information, the seller information and the transaction information, calculating a degree of exposure of a product based on an exposure degree calculation standard set for each transaction information, calculating a weighted degree of exposure for each distribution channel of the product by assigning a weighted value set for each distribution channel to the calculated degree of exposure, selecting a predetermined number of distribution channels in descending order of the weighted degree of exposure, and posting the product information on a corresponding distribution channel; and
an electronic commerce device for intermediating electronic commerce based on the product information received from the transaction information management device.

15. The system according to claim 14, further comprising an advertisement device for posting an advertisement corresponding to the product information according to the product information received from the transaction information management device.

16. A control method of a product transaction information management device, the method comprising:
(a) receiving product information and seller information through a network and registering the information;
(b) collecting and storing information on a transaction concluded according to the product information;
(c) receiving the product information, the seller information and the transaction information and calculating a degree of exposure of a product based on an exposure degree calculation standard set for each transaction information;
(d) calculating a weighted degree of exposure for each distribution channel of the product by assigning a weighted value set for each distribution channel to the calculated degree of exposure; and
(e) selecting a predetermined number of distribution channels in descending order of the weighted degree of exposure and transmitting the product information on a corresponding distribution channel.

17. The method according to claim 16, wherein the product information includes at least any one or more of a product name, a product category, a product keyword, a product description, a price and a selling period of the product, and the transaction information includes at least any one or more of a transaction date, a transaction time, a dealing price, a seller location, a payment frequency and a payment location.

18. The method according to claim 16, wherein step (e) includes the step of selecting a predetermined number of distribution channels in descending order of the weighted degree of exposure and transmitting the product information to at least any one of an online electronic commerce site, an online advertisement site and a mobile advertisement site.
